(19) United States
(12) Patent Application Publication
(10) Pub. No.: US 2026/0136001 A1
(43) Pub. Date: May 14, 2026

(54) Method and Apparatus of Adaptive Loop Filter Selection for Positional Taps in Video Coding

(71) Applicant: MEDIATEK INC., Hsinchu City (TW)

(72) Inventors: Shih-Chun CHIU, Hsinchu City (TW); Ching-Yeh CHEN, Hsinchu City (TW)

(21) Appl. No.: 19/118,916

(22) PCT Filed: Sep. 18, 2023
(86) PCT No.: PCT/CN2023/119368

§ 371 Date: Apr. 7, 2025

Related U.S. Application Data
(60) Provisional application No. 63/379,923, filed on Oct. 18, 2022.
(60) Provisional application No. 63/380,590, filed on Oct. 24, 2022.

(51) Int. Cl. H04N 19/117; H04N 19/176; H04N 19/82

(52) U.S. Cl. CPC H04N 19/117; H04N 19/176; H04N 19/82

(57) ABSTRACT

A method and apparatus for video coding using ALF. According to the method, a target ALF comprising one or more positional taps and a position function associated with at least one positional tap outputs a variable is derived. A current filtered output is derived by applying the target ALF to the current block. Filtered-reconstructed pixels comprising the current filtered output are provided. According to another method, a target horizontal period and a target vertical period are determined explicitly or implicitly, wherein the target horizontal period is determining among a set of horizontal periods and the target vertical period is determining among a set of vertical periods. A target ALF comprising one or more positional taps is determined, wherein a total number of said one or more positional taps and one or more corresponding position functions are dependent on the target horizontal period and the target vertical period.

### CROSS REFERENCE TO RELATED APPLICATIONS

The present invention is a non-Provisional Application of and claims priority to U.S. Provisional Patent Application No. 63/379,923, filed on Oct. 18, 2022 and U.S. Provisional Patent Application No. 63/380,590, filed on Oct. 24, 2022. The U.S. Provisional Patent Applications are hereby incorporated by reference in their entireties.

### FIELD OF THE INVENTION

The present invention relates to video coding system using ALF (Adaptive Loop Filter). In particular, the present invention relates to ALF filter selection and signalling for positional taps.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Adaptive Loop Filter in VVC

In VVC, an Adaptive Loop Filter (ALF) with block-based filter adaption is applied. For the luma component, one filter is selected among 25 filters for each 4×4 block, based on the direction and activity of local gradients.

### Filter Shape

Two diamond filter shapes (as shown in FIG. 2) are used. The 7×7 diamond shape 220 is applied for luma component and the 5×5 diamond shape 210 is applied for chroma components.

### Block Classification

For luma component, each 4×4 block is categorized into one out of 25 classes. The classification index C is derived based on its directionality D and a quantized value of activity Â, as follows:

$$C = 5 D + Â .$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert ,$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert ,$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert ,$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert ,$$

where indices i and j refer to the coordinates of the upper left sample within the 4×4 block and R(i,j) indicates a reconstructed sample at coordinate (i,j).

To reduce the complexity of block classification, the subsampled 1-D Laplacian calculation is applied to the vertical direction (FIG. 3A) and the horizontal direction (FIG. 3B). As shown in FIGS. 3C-D, the same subsampled positions are used for gradient calculation of all directions (g_{d1} in FIG. 3C and g_{d2} in FIG. 3D).

Then D maximum and minimum values of the gradients of horizontal and vertical directions are set as:

$${g}_{h , v}^{max} = max ( {g}_{h} , {g}_{v} ) , {g}_{h , v}^{min} = min ( {g}_{h} , {g}_{v} ) .$$

The maximum and minimum values of the gradient of two diagonal directions are set as:

$${g}_{d0 , d 1}^{max} = max ( {g}_{d 0} , {g}_{d 1} ) , {g}_{d0 , d 1}^{min} = min ( {g}_{d 0} , {g}_{d 1} ) .$$

To derive the value of the directionality D, these values are compared against each other and with two thresholds t₁ and t₂:
Step 1. If both

$${g}_{h , v}^{max} \leq {t}_{1} \cdot {g}_{h , v}^{min} and {g}_{d0 , d 1}^{max} \leq {t}_{1} \cdot {g}_{d0 , d 1}^{min}$$

are true, D is set to 0.
Step 2. If

$${g}_{h , v}^{max} / {g}_{h , v}^{min} > {g}_{d 0 , d 1}^{max} / {g}_{d 0 , d 1}^{min} ,$$

continue from Step 3; otherwise continue from Step 4.
Step 3. If

$${g}_{h , v}^{max} > {t}_{2} \cdot {g}_{h , v}^{min} ,$$

D is set to 2; otherwise D is set to 1.
Step 4. If

$${g}_{d0 , d 1}^{max} > {t}_{2} \cdot {g}_{d0 , d 1}^{min} ,$$

D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as Â.

For chroma components in a picture, no classification is applied.

### Geometric Transformations of Filter Coefficients and Clipping Values

Before filtering each 4×4 luma block, geometric transformations such as rotation or diagonal and vertical flipping are applied to the filter coefficients f(k, l) and to the corresponding filter clipping values c(k, l) depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal \text{:} {f}_{D} ( k , l ) = f ( l , k ) , {c}_{D} ( k , l ) = c ( l , k ) ,$$

$$Vertical flip \text{:} {f}_{V} ( k , l ) = f ( k , K - l - 1 ) , {c}_{V} ( k , l ) = c ( k , K - l - 1 ) ,$$

$$Rotation \text{:} {f}_{R} ( k , l ) = f ( K - l - 1 , k ) , {c}_{R} ( k , l ) = c ( K - l - 1 , k ) ,$$

where K is the size of the filter and 0≤k, l≤K−1 are coefficients coordinates, such that location (0,0) is at the upper left corner and location (K−1, K−1) is at the lower right corner. The transformations are applied to the filter coefficients f(k, l) and to the clipping values c(k, l) depending on gradient values calculated for that block. The relationship between the transformation and the four gradients of the four directions are summarized in the following table.

TABLE 1
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### Filtering Process

At decoder side, when ALF is enabled for a CTB, each sample R(i,j) within the CU is filtered, resulting in sample value R′(i,j) as shown below,

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) >> 7. )$$

where f(k, l) denotes the decoded filter coefficients, K(x, y) is the clipping function and c(k, l) denotes the decoded clipping parameters. The variable k and l varies between −L/2 and L/2, where L denotes the filter length. The clipping function K(x, y)=min (y, max(−y, x)) which corresponds to the function Clip3 (−y, y, x). The clipping operation introduces non-linearity to make ALF more efficient by reducing the impact of neighbour sample values that are too different with the current sample value.

### Cross Component Adaptive Loop Filter

CC-ALF uses luma sample values to refine each chroma component by applying an adaptive, linear filter to the luma channel and then using the output of this filtering operation for chroma refinement. FIG. 4A provides a system level diagram of the CC-ALF process with respect to the SAO, luma ALF and chroma ALF processes. As shown in FIG. 4A, each colour component (i.e., Y, Cb and Cr) is processed by its respective SAO (i.e., SAO Luma 410, SAO Cb 412 and SAO Cr 414). After SAO, ALF Luma 420 is applied to the SAO-processed luma and ALF Chroma 430 is applied to SAO-processed Cb and Cr. However, there is a cross-component term from luma to a chroma component (i.e., CC-ALF Cb 422 and CC-ALF Cr 424). The outputs from the cross-component ALF are added (using adders 432 and 434 respectively) to the outputs from ALF Chroma 430.

Filtering in CC-ALF is accomplished by applying a linear, diamond shaped filter (e.g. filters 440 and 442 in FIG. 4B) to the luma channel. In FIG. 4B, a blank circle indicates a luma sample and a dot-filled circle indicate a chroma sample. One filter is used for each chroma channel, and the operation is expressed as:

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} )$$

where (x, y) is chroma component i location being refined, (x_{Y},y_{Y}) is the luma location based on (x, y), Sᵢ is filter support area in luma component, and cᵢ(x₀, y₀) represents the filter coefficients.

As shown in FIG. 4B, the luma filter support is the region collocated with the current chroma sample after accounting for the spatial scaling factor between the luma and chroma planes.

In the VVC reference software, CC-ALF filter coefficients are computed by minimizing the mean square error of each chroma channel with respect to the original chroma content. To achieve this, the VTM (VVC Test Model) algorithm uses a coefficient derivation process similar to the one used for chroma ALF. Specifically, a correlation matrix is derived, and the coefficients are computed using a Cholesky decomposition solver in an attempt to minimize a mean square error metric. In designing the filters, a maximum of 8 CC-ALF filters can be designed and transmitted per picture. The resulting filters are then indicated for each of the two chroma channels on a CTU basis.

### Additional Characteristics of CC-ALF Include:

The design uses a 3×4 diamond shape with 8 taps.
Seven filter coefficients are transmitted in the APS.
Each of the transmitted coefficients has a 6-bit dynamic range and is restricted to power-of-2 values.
The eighth filter coefficient is derived at the decoder such that the sum of the filter coefficients is equal to 0.
An APS may be referenced in the slice header.
CC-ALF filter selection is controlled at CTU-level for each chroma component.
Boundary padding for the horizontal virtual boundaries uses the same memory access pattern as luma ALF.

As an additional feature, the reference encoder can be configured to enable some basic subjective tuning through the configuration file. When enabled, the VTM attenuates the application of CC-ALF in regions that are coded with high QP and are either near mid-grey or contain a large amount of luma high frequencies. Algorithmically, this is accomplished by disabling the application of CC-ALF in CTUs where any of the following conditions are true:
The slice QP value minus 1 is less than or equal to the base QP value.
The number of chroma samples for which the local contrast is greater than (1<<(bitDepth−2))−1 exceeds the CTU height, where the local contrast is the difference between the maximum and minimum luma sample values within the filter support region.
More than a quarter of chroma samples are in the range between

$$( 1 << ( bitDepth - 1 ) ) - 16 and ( 1 << ( bitDepth - 1 ) ) + 16$$

The motivation for this functionality is to provide some assurance that CC-ALF does not amplify artefacts introduced earlier in the decoding path (This is largely due the fact that the VTM currently does not explicitly optimize for chroma subjective quality). It is anticipated that alternative encoder implementations may either not use this functionality or incorporate alternative strategies suitable for their encoding characteristics.

### Filter Parameters Signalling

ALF filter parameters are signalled in Adaptation Parameter Set (APS). In one APS, up to 25 sets of luma filter coefficients and/or clipping value indexes, and up to eight sets of chroma filter coefficients and/or clipping value indexes could be signalled. To reduce bits overhead, filter coefficients of different classification for luma component can be merged. In slice header, the indices of the APSs used for the current slice are signalled.

Clipping value indexes, which are decoded from the APS, allow determining clipping values using a table of clipping values for both luma and Chroma components. These clipping values are dependent of the internal bitdepth. More precisely, the clipping values are obtained by the following formula:

$$AlfClip = \{ rou nd ( {2}^{B - α * n} ) for n ∈ [ 0 .. N - 1 ] \}$$

with B equal to the internal bitdepth, a is a pre-defined constant value equal to 2.35, and N equal to 4 which is the number of allowed clipping values in VVC. The AlfClip is then rounded to the nearest value with the format of power of 2.

In slice header, up to 7 APS indices can be signalled to specify the luma filter sets that are used for the current slice. The filtering process can be further controlled at CTB level. A flag is always signalled to indicate whether ALF is applied to a luma CTB. A luma CTB can choose a filter set among 16 fixed filter sets and the filter sets from APSs. A filter set index is signalled for a luma CTB to indicate which filter set is applied. The 16 fixed filter sets are pre-defined and hard-coded in both the encoder and the decoder.

For the chroma component, an APS index is signalled in slice header to indicate the chroma filter sets being used for the current slice. At CTB level, a filter index is signalled for each chroma CTB if there is more than one chroma filter set in the APS.

The filter coefficients are quantized with norm equal to 128. In order to restrict the multiplication complexity, a bitstream conformance is applied so that the coefficient value of the non-central position shall be in the range of −2⁷ to 2⁷−1, inclusive. The central position coefficient is not signalled in the bitstream and is considered as equal to 128.

### Adaptive Loop Filter in ECM

### ALF Simplification

ALF gradient subsampling and ALF virtual boundary processing are removed. Block size for classification is reduced from 4×4 to 2×2. Filter size for both luma and chroma, for which ALF coefficients are signalled, is increased to 9×9.

ALF with Fixed Filters

To filter a luma sample, three different classifiers (C₀, C₁ and C₂) and three different sets of filters (F₀, F₁ and F₂) are used. Sets F₀ and F₁ contain fixed filters, with coefficients trained for classifiers C₀ and C₁. Coefficients of filters in F₂ are signalled. Which filter from a set Fᵢ is used for a given sample is decided by a class Cᵢ assigned to this sample using classifier Cᵢ.

### Filtering

At first, two 13×13 diamond shape fixed filters F₀ and F₁ are applied to derive two intermediate samples R₀(x,y) and R₁(x,y). After that, F₂ is applied to R₀(x,y), R₁(x,y), and neighbouring samples to derive a filtered sample as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] ,$$

where f_{i,j} is the clipped difference between a neighbouring sample and current sample R(x,y) and gᵢ is the clipped difference between Rᵢ₋₂₀(x,y) and current sample. The filter coefficients cᵢ, i=0, . . . 21, are signalled.

### Classification

Based on directionality Dᵢ and activity Âᵢ, a class Cᵢ is assigned to each 2×2 block:

$${C}_{i} = {\hat{A}}_{i} * {M}_{D , i} + {D}_{i} ,$$

where M_{D,i} represents the total number of directionalities Dᵢ.

As in VVC, values of the horizontal, vertical, and two diagonal gradients are calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ is determined by comparing

$${r}_{h , v}^{i} = \frac{max ( {g}_{h}^{i} , {g}_{v}^{i} )}{min ( {g}_{h}^{i} , {g}_{v}^{i} )} ,$$

$${r}_{d 1 , d 2}^{i} = \frac{max ( {g}_{d 1}^{i} , {g}_{d 2}^{i} )}{min ( {g}_{d 1}^{i} , {g}_{d 2}^{i} )} ,$$

with a set of thresholds. The directionality D₂ is derived as in VVC using thresholds 2 and 4.5. For D₀ and D₁, horizontal/vertical edge strength

$${E}_{HV}^{i}$$

and diagonal edge strength

$${E}_{D}^{i}$$

are calculated first. Thresholds Th=[1.25, 1.5,2, 3,4.5, 8] are used. Edge strength

$${E}_{HV}^{i} is 0 if {r}_{h , v}^{i} \leq Th [ 0 ] ;$$

otherwise,

$${E}_{HV}^{i}$$

is the maximum integer such that

$${r}_{h , v}^{i} > Th [ {E}_{HV}^{i} - 1 ] .$$

Edge strength

$${E}_{D}^{i} is 0 if {r}_{d 1 , d 2}^{i} \leq T h [ 0 ] ;$$

otherwise,

$${E}_{D}^{i}$$

is the maximum integer such that

$${r}_{d 1 , d 2}^{i} > T h [ {E}_{D}^{i} - 1 ] .$$

### When

$${r}_{h , v}^{i} > {r}_{d 1 , d 2}^{i} ,$$

i.e., horizontal/vertical edges are dominant, the Dᵢ is derived by using Table 2A; otherwise, diagonal edges are dominant, the Dᵢ is derived by using Table 2B.

TABLE 2A
$Mapping of {E}_{D}^{i} and {E}_{H V}^{i} to {D}_{i}$

| | ${E}_{D}^{i}$ | | | | | | |
|---|---|---|---|---|---|---|---|
| ${E}_{HV}^{i}$ | 0 | 1 | 2 | 3 | 4 | 5 | 6 |
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2B
$Mapping of {E}_{D}^{i} and {E}_{H V}^{i} to {D}_{i}$

| | ${E}_{HV}^{i}$ | | | | | | |
|---|---|---|---|---|---|---|---|
| ${E}_{D}^{i}$ | 0 | 1 | 2 | 3 | 4 | 5 | 6 |
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Â₂ and 15 for Â₀ and Â₁.

In an ALF_APS, up to 4 luma filter sets are signalled, each set may have up to 25 filters.

In the present invention, ALF with positional taps is disclosed.

### BRIEF SUMMARY OF THE INVENTION

A method and apparatus for video coding using ALF (Adaptive Loop Filter) are disclosed. According to the method, reconstructed pixels associated with a current block are received. A target ALF is derived, wherein the ALF comprises one or more positional taps and a position function associated with at least one positional tap outputs a variable. A current filtered output is derived by applying the target ALF to the current block. Filtered-reconstructed pixels are provided, wherein the filtered-reconstructed pixels comprise the current filtered output.

In one embodiment, the variable is related to a current sample value for a current sample, one or more neighbouring sample values for one or more neighbouring samples of the current sample, or both.

In one embodiment, the position function outputs the variable or a constant depending on a condition related to pixel position in horizontal and vertical directions. In one embodiment, the variable comprises a pre-determined function with the current sample value, said one or more neighbouring sample values, or both as input data. In one embodiment, the pre-determined function comprises a clipping function to clip a target input value. In one embodiment, the target input value corresponds to a scaled current sample value. In another embodiment, the target input value corresponds to a difference between the current sample value and one of said one or more neighbouring sample values.

In one embodiment, the variable comprises a first clipping function applied to a first difference between the current sample value and a first neighbouring sample value of a first neighbouring sample, and a second clipping function applied to a second difference between the current sample value and a second neighbouring sample value of a second neighbouring sample, and wherein the first neighbouring sample and the second neighbouring sample are located at symmetric locations with respect to the current sample.

In one embodiment, the variable comprises a first clipping function applied to the current sample value multiplied by a first scaled current sample value, and a second clipping function applied to a second scaled current sample value.

In one embodiment, the variable is related to one or more source values of one or more respective existing taps. In one embodiment, each source value corresponds to a clipped neighbouring difference value, a first correction value from another filter, or a second correction value from another in-loop filtering stage. In another embodiment, the variable corresponds to a linear function or a quadratic function. In one embodiment, the position function outputs the variable or a constant depending on a condition related to pixel position in horizontal and vertical directions.

According to another method, reconstructed pixels associated with a current block are received. A target horizontal period and a target vertical period are determined explicitly or implicitly, wherein the target horizontal period is determining among a set of horizontal periods and the target vertical period is determining among a set of vertical periods. A target ALF comprising one or more positional taps is determined, wherein a total number of said one or more positional taps and one or more corresponding position functions are dependent on the target horizontal period and the target vertical period. A current filtered output is derived by applying the target ALF to the current block. Filtered-reconstructed pixels are provided, wherein the filtered-reconstructed pixels comprise the current filtered output.

In one embodiment, the target horizontal period and the target vertical period are signalled or parsed explicitly in a bitstream. In one embodiment, the target horizontal period and the target vertical period are signalled or parsed separately using separate indices. In another embodiment, the target horizontal period and the target vertical period are signalled or parsed jointly using an index to select the target horizontal period and the target vertical period from a set of pre-determined period pairs.

In one embodiment, at most M×N coefficients and/or clipping indices associated with said one or more positional taps are signalled or parsed per filter in APS (Adaptation Parameter Set) level, and wherein M and N are positive integers representing the target horizontal period and the target vertical period respectively.

In one embodiment, at most M×N coefficients and/or clipping indices associated with said one or more positional taps are signalled or parsed per filter in a filter set.

In one embodiment, one or more coefficients and/or clipping indices associated with said one or more positional taps are signalled or parsed in a filter level.

In one embodiment, the target horizontal period and the target vertical period are signalled or parsed in APS (Adaptation Parameter Set) level, and at most M×N coefficients and/or clipping indices associated with said one or more positional taps are signalled per filter set in the APS level for all filters in the filter set.

In one embodiment, the target horizontal period and the target vertical period are signalled or parsed in a filter set level, and at most M×N coefficients and/or clipping indices associated with said one or more positional taps are signalled or parsed in the filter set level for all filters in the filter set.

In one embodiment, one or more coefficients and/or clipping indices associated with said one or more positional taps are signalled or parsed in a first level different from a second level for signalling or parsing non-positional taps.

In one embodiment, one or more coefficients and/or clipping indices associated with said one or more positional taps are signalled or parsed in a slice level and information for non-positional taps are signalled or parsed in APS level.

In one embodiment, the target horizontal period and the target vertical period are implicitly derived based on a scaling factor. In one embodiment, the scaling factor is dependent on picture resolution.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the ALF filter shapes for the chroma (left) and luma (right) components.

FIGS. 3A-D illustrates the subsampled Laplacian calculations for gᵥ (3A), gₕ (3B), g_{d1} (3C) and g_{d2} (3D).

FIG. 4A illustrates the placement of CC-ALF with respect to other loop filters.

FIG. 4B illustrates a diamond shaped filter for the chroma samples.

FIG. 5 illustrates a flowchart of an exemplary video coding system that utilizes diversified positional ALF according to an embodiment of the present invention.

FIG. 6 illustrates a flowchart of an exemplary video coding system that signals the horizontal and vertical periods for diversified positional ALF according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the following, a scheme of deriving, signalling and utilising diversified positional tap ALFs are disclosed.

### ALF Filter Shape Selection for Positional Taps

In general, ALF reconstruction process can be represented by:

$$\tilde{R} ( x , y ) = R ( x , y ) + [ {\sum }_{i = 0}^{K - 1} {c}_{i} {n}_{i} ] ,$$

where R(x,y) is the sample value before ALF filtering, \tilde{R}(x,y) is the sample value after ALF filtering, cᵢ is the i-th filter coefficient, and nᵢ is the i-th filter tap input. Specially, nᵢ can be a clipped neighbouring difference value, a correction value from another filter, or a correction value from anther in-loop filtering stage. In some cases, positional taps can be added to the reconstruction equation:

$$\tilde{R} ( x , y ) = R ( x , y ) + [ {\sum }_{i = 0}^{K - 1} {c}_{i} {n}_{i} ] + [ {\sum }_{i = 0}^{P - 1} {c}_{i + K} {f}_{i} ( x , y ) ] ,$$

where the additional P terms are positional taps, and fᵢ(x, y) is the position embedding function which takes current sample position (x, y) as input.

However, for different sequences, the positional property may be different. In this invention, a filter shape selection mechanism for positional taps is illustrated to adaptively change the positional taps used in ALF.

In one embodiment, a horizontal period M and a vertical period N are explicitly signalled. The number of positional taps P and the position embedding functions fᵢ(x, y) are determined according to M and N. For example, one positional tap is for samples at one specific position in each M×N block. Specifically, P=M×N and fᵢ(x, y) are defined as follows:

$$\begin{matrix}{f}_{0} ( x , y ) = ( x mod M == 0 \&\& y mod N == 0 ) ? C : 0 , \\ {f}_{1} ( x , y ) = ( x mod M == 1 \&\& y mod N == 0 ) ? C : 0 , \\ … \\ {f}_{M n + m} ( x , y ) = ( x mod M == m \&\& y mod N == n ) ? C : 0 , \\ … \\ {f}_{M N - 1} ( x , y ) = ( x mod M == ( M - 1 ) \&\& y mod N == ( N - 1 ) ) ? C : 0 ,\end{matrix}$$

where “mod” represents the modulo operation and C is a pre-determined constant value or a value determined by the clipping index. Note that for different numbers of M and N, the number of positional taps P and position embedding functions fᵢ(x, y) may also be different.

For the period signalling (i.e., M and N) in the above embodiment, they can be signalled separately or jointly. In the latter case, one index is signalled to select from one period pair (M, N) from several pre-determined period pairs. Besides, the period information can be signalled at APS level, filter set level, or filter level. In the above example (P=M×N), if the periods are signalled at APS level, at most M×N coefficients and/or clipping indices of positional taps are signalled per filter in the APS; if the periods are signalled at filter set level, at most M×N coefficients and/or clipping indices of positional taps are signalled per filter in the filter set; if the periods are signalled at filter level, M×N coefficients and/or clipping indices of positional taps are signalled in the filter.

In the above embodiment, coefficients and/or clipping indices of positional taps can be signalled at a higher level than those of other taps. For example, if periods are signalled at APS level, at most M×N coefficients and/or clipping indices of positional taps are signalled per filter set in the APS instead of per filter, and these coefficients and/or clipping indices of positional taps are shared for all filters in the filter set. If the periods are signalled at the filter set level, M×N coefficients and/or clipping indices of positional taps are signalled, and these coefficients and/or clipping indices of positional taps are shared for all filters in the filter set.

In the above embodiment, coefficients and/or clipping indices of positional taps can be signalled at a different level than those of other taps. For example, the positional taps are signalled at the slice level. In such design, the positional taps signalled at the slice level are combined with the other taps signalled in APS to form a filter for ALF reconstruction.

In another embodiment, a horizontal period M and a vertical period N are implicitly derived based on a scaling factor. The number of positional taps P and the position embedding functions fᵢ(x, y) are determined according to M and N. For example, if M=4 and N=2 are used for the original resolution (i.e., scaling factor=1), M=4*0.5=2 and N=2*0.5=1 are used for the half resolution (i.e., scaling factor=0.5). Note that this method is useful when enabling the coding tools that change the picture resolution such as reference picture resampling (RPR).

In the above embodiment, if one history APS is from a frame with a coding resolution different from the current frame, the positional taps of the filters from this APS are disabled for the current frame to prevent the period mismatch.

ALF with Diversified Positional Taps

In one embodiment, each positional tap is only activated for a subset of samples in a current coding region, where whether one sample belongs to the subset or not is determined by the position of the sample. If one position tap is not activated for a sample, the corresponding position embedding function output is 0. If one positional tap is activated for a sample, the corresponding position embedding function output can be a constant offset (e.g. Examples 1 and 2 below), a variable related to current and/or neighbouring sample values (e.g. Example 3 below), or a variable related to the source values (nᵢ) of the existing taps (e.g. Example 4 below).

Example 1. There are 4 positional taps with the position embedding functions defined as:

$${f}_{0} ( x , y ) = ( x mod 2 == 0 \&\& y mod 2 == 0 ) ? C : 0 ,$$

$${f}_{1} ( x , y ) = ( x mod 2 == 1 \&\& y mod 2 == 0 ) ? C : 0 ,$$

$${f}_{2} ( x , y ) = ( x mod 2 == 0 \&\& y mod 2 == 1 ) ? C : 0 ,$$

$${f}_{3} ( x , y ) = ( x mod 2 == 1 \&\& y mod 2 == 1 ) ? C : 0 ,$$

where “mod” represents modulus operation and C can be a pre-defined constant value or a value selected based on clipping index of the corresponding coefficient c_{i+K}.

Example 2. There are 3 positional taps with the position embedding functions defined as:

$${f}_{0} ( x , y ) = ( x mod 2 == 0 \&\& y mod 2 == 0 ) ? C : 0 ,$$

$${f}_{1} ( x , y ) = ( x mod 2 == 1 \&\& y mod 2 == 0 ) ‖ ( x mod 2 == 0 \&\& y mod 2 == 1 ) ? C : 0 ,$$

$${f}_{2} ( x , y ) = ( x mod 2 == 1 \&\& y mod 2 == 1 ) ? C : 0.$$

Example 3. The positional taps follow almost the same design in Example 1 with the modification to C.

$${f}_{0} ( x , y ) = ( x mod 2 == 0 \&\& y mod 2 == 0 ) ? g ( R , x , y ) : 0 ,$$

$${f}_{1} ( x , y ) = ( x mod 2 == 1 \&\& y mod 2 == 0 ) ? g ( R , x , y ) : 0 ,$$

$${f}_{2} ( x , y ) = ( x mod 2 == 0 \&\& y mod 2 == 1 ) ? g ( R , x , y ) : 0 ,$$

$${f}_{3} ( x , y ) = ( x mod 2 == 01 \&\& y mod 2 == 1 ) ? g ( R , x , y ) : 0 ,$$

where g(R, x, y) is a pre-determined function that takes the current processing sample value R (x, y) and/or its neighbouring sample values R(x+p, y+q) as input, where p and q are integers. Some exemplary function forms for g(R, x, y) are shown as follows:

$$g ( R , x , y ) = Clip ( a * R ( x , y ) ) + b ,$$

$$g ( R , x , y ) = Clip ( ( R ( x + p , y + q ) - R ( x , y ) ) ) ,$$

$$g ( R , x , y ) = Clip ( ( R ( x + p , y + q ) - R ( x , y ) ) ) + Clip ( ( R ( x - p , y - q ) - R ( x , y ) ) ) ,$$

where a and b are pre-determined integers, and Clip(represents the clipping function same as the one used for the existing ALF taps.

Example 4. The positional taps follow almost the same design in Example 3 with the modification to g(R, x, y):

$${f}_{0} ( x , y ) = ( x mod 2 == 0 \&\& y mod 2 == 0 ) ? h ( {n}_{i} ) : 0 ,$$

$${f}_{1} ( x , y ) = ( x mod 2 == 1 \&\& y mod 2 == 0 ) ? h ( {n}_{i} ) : 0 ,$$

$${f}_{2} ( x , y ) = ( x mod 2 == 0 \&\& y mod 2 == 1 ) ? h ( {n}_{i} ) : 0 ,$$

$${f}_{3} ( x , y ) = ( x mod 2 == 1 \&\& y mod 2 == 1 ) ? h ( {n}_{i} ) : 0 ,$$

where h(nᵢ) is a pre-determined function that takes the source of one existing tap nᵢ as input. An exemplary function form for h(nᵢ) is:

$$h ( {n}_{i} ) = a * {n}_{i} + b ,$$

where a and b are pre-determined integers. Note that the clipping operation of this tap is already in the derivation of nᵢ. In such design, if nₜ is used in positional tap, the original existing tap can be removed, resulting in the following filtering equation:

$$\tilde{R} ( x , y ) = R ( x , y ) + [ {\sum }_{\begin{matrix}i = 0 \\ i \neq t\end{matrix}}^{K - 1} {c}_{i} {n}_{i} ] + [ {\sum }_{i = 0}^{3} {c}_{i + K} {f}_{i} ( x , y ) ] .$$

In the above embodiment, the positional taps in each example can be combined.

Example 5. This example shows a combination of example 1 and Example 4. There are 8 positional taps in total.

$${f}_{0} ( x , y ) = ( x mod 2 == 0 \&\& y mod 2 == 0 ) ? C : 0 ,$$

$${f}_{1} ( x , y ) = ( x mod 2 == 0 \&\& y mod 2 == 0 ) ? h ( {n}_{i} ) : 0 ,$$

$${f}_{2} ( x , y ) = ( x mod 2 == 1 \&\& y mod 2 == 0 ) ? C : 0 ,$$

$${f}_{3} ( x , y ) = ( x mod 2 == 1 \&\& y mod 2 == 0 ) ? h ( {n}_{i} ) : 0 ,$$

$${f}_{4} ( x , y ) = ( x mod 2 == 0 \&\& y mod 2 == 1 ) ? C : 0 ,$$

$${f}_{5} ( x , y ) = ( x mod 2 == 0 \&\& y mod 2 == 1 ) ? h ( {n}_{i} ) : 0 ,$$

$${f}_{6} ( x , y ) = ( x mod 2 == 1 \&\& y mod 2 == 1 ) ? C : 0 ,$$

$${f}_{7} ( x , y ) = ( x mod 2 == 1 \&\& y mod 2 == 1 ) ? h ( {n}_{i} ) : 0 ,$$

In this example, for each type of position, there are 2 coefficients that form a linear model to refine the sample. Note that h(nᵢ) can be replaced with g(R, x, y) in Example 3, which results in a combination of Examples 1 and 3.

In the above embodiments, more nonlinearity can be introduced in g(R, x,y) and h(nᵢ). For example, a second-degree term can be used:

$$g ( R , x , y ) = Clip ( a * {( R ( x , y ) )}^{2} ) + Clip ( b * R ( x , y ) ) + c$$

$$h ( {n}_{i} ) = a * {n}_{i}^{2} + b * {n}_{i} + c .$$

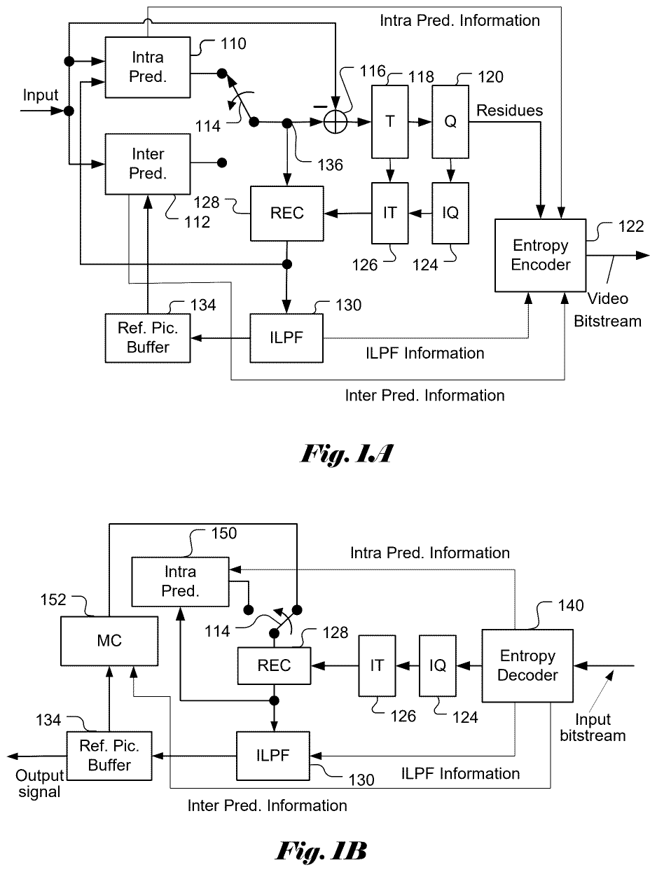

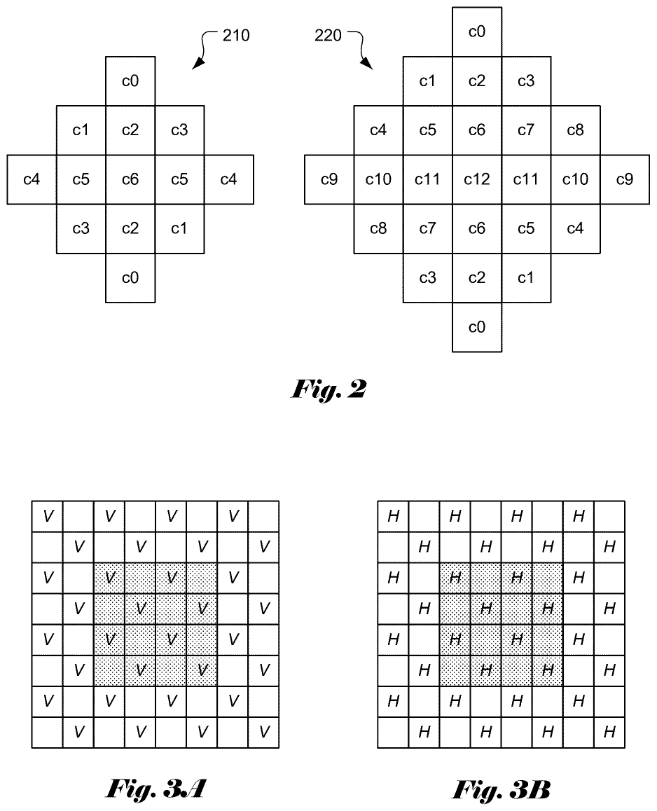

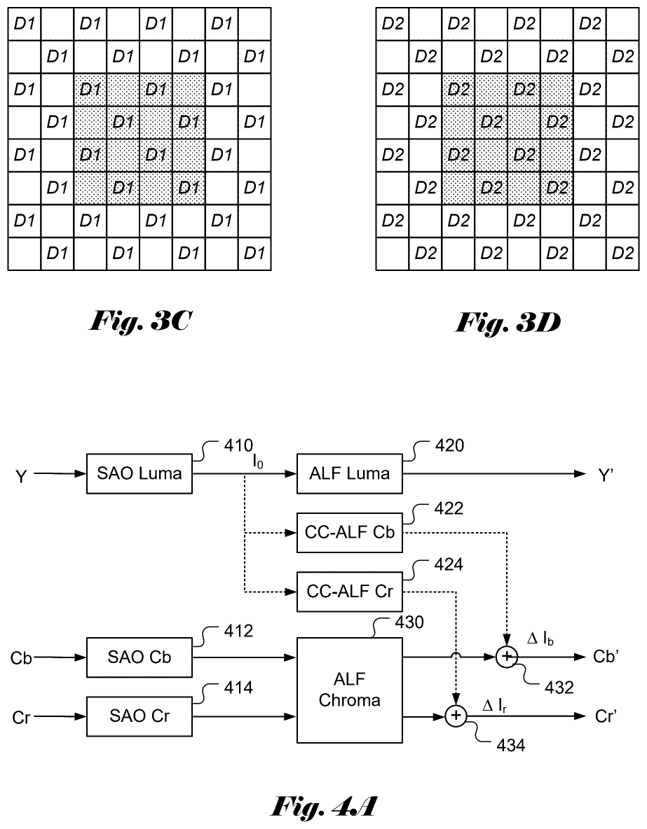

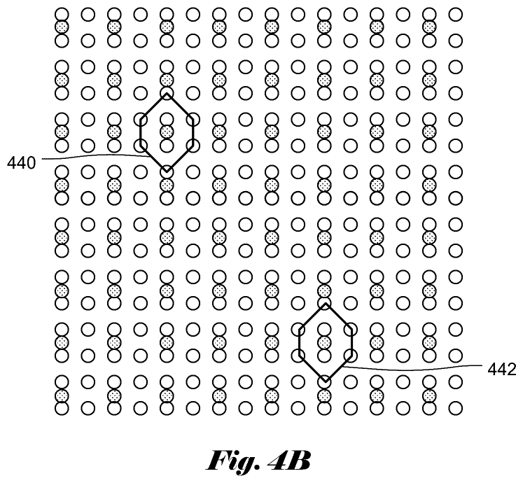

Any of the ALF as described above can be implemented in encoders and/or decoders. For example, any of the proposed methods can be implemented in the in-loop filter module (e.g. TLPF 130 in FIG. 1A and FIG. 1B) of an encoder or a decoder. Alternatively, any of the proposed methods can be implemented as a circuit coupled to the inter coding module of an encoder and/or motion compensation module, a merge candidate derivation module of the decoder. The ALF methods may also be implemented using executable software or firmware codes stored on a media, such as hard disk or flash memory, for a CPU (Central Processing Unit) or programmable devices (e.g. DSP (Digital Signal Processor) or FPGA (Field Programmable Gate Array)).

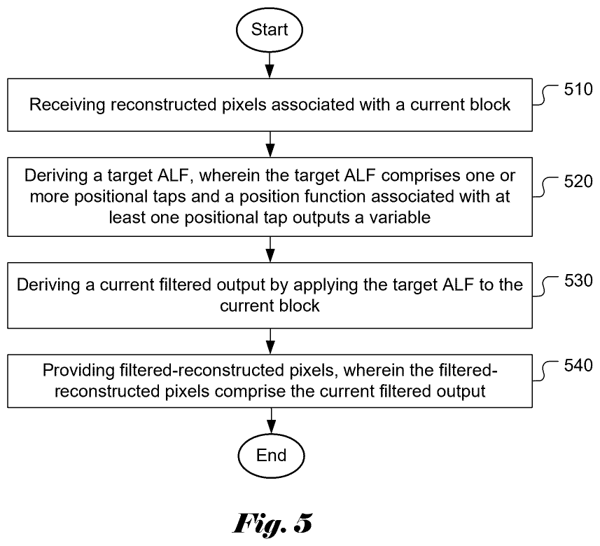

FIG. 5 illustrates a flowchart of an exemplary video coding system that utilizes diversified positional ALF according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, reconstructed pixels associated with a current block are received in step 510. A target ALF is derived in step 520, wherein the ALF comprises one or more positional taps and a position function associated with at least one positional tap outputs a variable. A current filtered output is derived by applying the target ALF to the current block in step 530. Filtered-reconstructed pixels are provided in step 540, wherein the filtered-reconstructed pixels comprise the current filtered output.

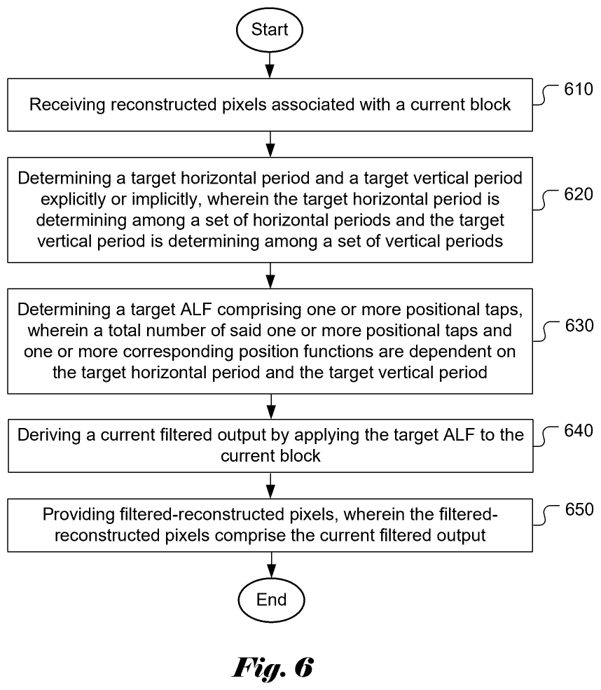

FIG. 6 illustrates a flowchart of an exemplary video coding system that signals the horizontal and vertical periods for diversified positional ALF according to an embodiment of the present invention. According to this method, reconstructed pixels associated with a current block are received in step 610. A target horizontal period and a target vertical period are determined explicitly or implicitly in step 620, wherein the target horizontal period is determining among a set of horizontal periods and the target vertical period is determining among a set of vertical periods. A target ALF comprising one or more positional taps is determined in step 630, wherein a total number of said one or more positional taps and one or more corresponding position functions are dependent on the target horizontal period and the target vertical period. A current filtered output is derived by applying the target ALF to the current block in step 640. Filtered-reconstructed pixels are provided, wherein the filtered-reconstructed pixels comprise the current filtered output in step 650.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for Adaptive Loop Filter (ALF) processing of reconstructed video, the method comprising:
receiving reconstructed pixels associated with a current block;
deriving a target ALF, wherein the target ALF comprises one or more positional taps and a position function associated with at least one positional tap outputs a variable;
deriving a current filtered output by applying the target ALF to the current block; and
providing filtered-reconstructed pixels, wherein the filtered-reconstructed pixels comprise the current filtered output.

2. The method of claim 1, wherein the variable is related to a current sample value for a current sample, one or more neighbouring sample values for one or more neighbouring samples of the current sample, or both.

3. The method of claim 2, wherein the variable comprises a pre-determined function with the current sample value, said one or more neighbouring sample values, or both as input data.

4. (canceled)

5. (canceled)

6. (canceled)

7. (canceled)

8. (canceled)

9. The method of claim 1, wherein output of the position function depends on a condition related to pixel position in horizontal and vertical directions.

10. (canceled)

11. The method of claim 1, wherein the variable is related to one or more source values of one or more respective existing taps.

12. (canceled)

13. (canceled)

14. (canceled)

15. An apparatus for Adaptive Loop Filter (ALF) processing of reconstructed video, the apparatus comprising one or more electronics or processors arranged to:
receive reconstructed pixels associated with a current block;
derive a target ALF, wherein the target ALF comprises one or more positional taps and a position function associated with at least one positional tap outputs a variable;
derive a current filtered output by applying the target ALF to the current block; and
provide filtered-reconstructed pixels, wherein the filtered-reconstructed pixels comprise the current filtered output.

16. A method for Adaptive Loop Filter (ALF) processing of reconstructed video, the method comprising:
receiving reconstructed pixels associated with a current block;
determining a target horizontal period and a target vertical period explicitly or implicitly, wherein the target horizontal period is determining among a set of horizontal periods and the target vertical period is determining among a set of vertical periods;
determining a target ALF comprising one or more positional taps, wherein a total number of said one or more positional taps and one or more corresponding position functions are dependent on the target horizontal period and the target vertical period;
deriving a current filtered output by applying the target ALF to the current block; and
providing filtered-reconstructed pixels, wherein the filtered-reconstructed pixels comprise the current filtered output.

17. The method of claim 16, wherein the target horizontal period and the target vertical period are signalled or parsed explicitly in a bitstream.

18. The method of claim 17, wherein the target horizontal period and the target vertical period are signalled or parsed separately using separate indices.

19. The method of claim 17, wherein the target horizontal period and the target vertical period are signalled or parsed jointly using an index to select the target horizontal period and the target vertical period from a set of pre-determined period pairs.

20. The method of claim 16, wherein at most M×N coefficients and or clipping indices associated with said one or more positional taps are signalled or parsed per filter in APS (Adaptation Parameter Set) level, and wherein M and N are positive integers representing the target horizontal period and the target vertical period respectively.

21. (canceled)

22. (canceled)

23. (canceled)

24. (canceled)

25. The method of claim 16, wherein the target horizontal period and the target vertical period are signalled or parsed in APS (Adaptation Parameter Set) level.

26. (canceled)

27. The method of claim 16, wherein one or more coefficients and or clipping indices associated with said one or more positional taps are signalled or parsed in a first level different from a second level for signalling or parsing non-positional taps.

28. (canceled)

29. The method of claim 16, wherein the target horizontal period and the target vertical period are implicitly derived based on a scaling factor dependent on picture resolution.

30. (canceled)

31. An apparatus for Adaptive Loop Filter (ALF) processing of reconstructed video, the apparatus comprising one or more electronics or processors arranged to:
receive reconstructed pixels associated with a current block;
determine a target horizontal period and a target vertical period explicitly or implicitly, wherein the target horizontal period is determining among a set of horizontal periods and the target vertical period is determining among a set of vertical periods;
determine a target ALF comprising one or more positional taps, wherein a total number of said one or more positional taps and one or more corresponding position functions are dependent on the target horizontal period and the target vertical period;
derive a current filtered output by applying the target ALF to the current block; and
provide filtered-reconstructed pixels, wherein the filtered-reconstructed pixels comprise the current filtered output.
